(19) United States
(12) Patent Application Publication
(10) Pub. No.: US 2008/0172704 A1
(43) Pub. Date: Jul. 17, 2008

(54) Interactive audiovisual editing system

(76) Inventor: Peyman T. Montazemi, Van Nuys, CA (US)

Correspondence Address: Brian D. Laubscher;Suite 807, 2776 S. Arlington Mill Dr., Arlington, VA, 22206, US

(21) Appl. No.: 12/007,749

(22) Filed: Jan. 15, 2008

Related U.S. Application Data
(60) Provisional application No. 60/885,012, filed on Jan. 16, 2007.

(51) Int. Cl. H04N 7/173

(52) U.S. Cl. 725/105

(57) ABSTRACT

An interactive audiovisual editing system (IAVES) for providing the possibility of customizing and personalizing audiovisual/multimedia (AVMM) data/media comprises a hardware/software component that can respond to users' command inputs and process an AVMM data/media accordingly to the users' intention and display the processed data/media back to them via an AVMM display. An AVMM display allows users to view and listen to AVMM data/media. A controller allows users to enter AVMM command inputs into the system and interact with AVMM data/media via defined AVMM parameters. The command inputs can introduce user-defined objects such as graphics, animations, pictures, text files, audio files, video files, or any user-defined digital content. A new recording/filming format gives the IAVES users the option of viewing and listening to AVMM data/media in different audio and video formats including two-dimensional and three-dimensional formats. This system offers the possibility of using any existing AVMM format as well as the new AVMM format described above, which offers more interactivity to the IAVES users. This is done by allowing users to control additional AVMM parameters that are usually not controllable in other formats. A data storage device (remote or not) can store the changes made by the users as well as the final personalized data/media for later processing. The IAVES offers the possibility to connect to the outside world via a distributed network for sharing users-defined AVMM data/media.

### CROSS REFERENCE TO RELATED APPLICATIONS

This application claims the benefit of provisional patent application Ser. No. 60/885,012 filed Jan. 16, 2007.

### BACKGROUND OF THE INVENTION

1. Field of the Invention

This invention relates to an interactive audiovisual system (IAVS) that allows its users to edit, customize and personalize audiovisual/multimedia (AVMM) products by means of a controller, save the personalized product, and exchange the personalized product with the outside world using commercially available AVMM display systems through any existing network.

2. Description of the Related Art

Interactive technology is where users' involvement is at its highest degree, and participation is at the point where users feel that they are part of the AVMM product. Currently, existing IAVSs only offer users basic functions therefore there is a gap in the interactivity between users and products due to the lack of user-integration. More specifically, the current AVMM technologies are limited and do not allow any customization for use. On the other hand, within the last few years, interactive users have demonstrated through usage of interactive multimedia websites, e.g. YouTube.com and MySpace.com, their will to be involved more actively in AVMM products, but they were limited by the lack of customization present in current technologies. So, IAVS developers have long sought means of offering more interactivity to reduce the existing gap between users and products.

Another aspect of this invention is its new AVMM recording/filming format. The reason of such innovation is the following: due to the improvement and availability of digital technology, more and more AVMM products are “tweaked” in post-production phase such that the final product is of a much higher quality than the actual live performance during the production process. It is only when consumers see the actual live performance that the difference between produced and live products is largely noticeable. This phenomenon can be a negative publicity for performers/products and rather frustrating for the consumers, especially when it is known that the interaction between users and live performances is minimal. In order to improve the scenario described above, an editable AVMM product is proposed. What is meant by editable is that users have control over defined AVMM parameters of the product if and only if the proposed AVMM recording/filming format is used. What is meant by control over AVMM parameters is that users can change both audio and video settings thanks to this new AVMM recording/filming format, which will allow user-defined commands to happen. With this new AVMM recording/filming format, the quality of the product benefits of the highest digital technology, with an increased interactivity, and without loosing its live quality. It is important to notice that the interactivity described in this paragraph is made possible thanks to the new AVMM recording/filming format, which allows the users to input commands and change the AVMM settings by changing a list of given parameters, whereas the interactivity described in the previous paragraph involved the capability of personalizing any AVMM product including AVMM products that are not recorded/filmed in the new AVMM format, by introducing personal AVMM data, files, and/or media, saving the personalized AVMM product, and sharing it with IAVES and non-IAVES users over a distributed network. But what is also important is that the set of controlled AVMM parameters will be reduced if the selected AVMM format is any of the existing AVMM formats except the new proposed idea through the presented format.

Both U.S. Pat. No. 7,137,892 to Sitrick (2006) and U.S. Pat. No. 7,146,615 to Hervet et al. (2006) show interactive systems that could be applied to AVMM applications. These systems are described in a very general fashion but their interactivity is narrowed down to specific applications such as music composition or distribution of an audiovisual product over a network. Some users might not have any interest in music only, but rather audio and/or video. Other users could be interested in interacting more actively with a media such as changing any of the audiovisual formats or any of the display settings. But up to now, these options are not offered in the case of these two patents.

One could offer the capability of changing the audiovisual parameters of a media while it is being played. U.S. Pat. No. 7,162,075 to Littlefield (2007) uses an innovative image capturing system to reconstitute the three-dimensional image of an object in motion but there is no involvement of any sort of interactivity between users and the AVMM product offered by this technology. Furthermore, having the reconstituted three-dimensional image of an object in motion is an achievement. But this does not allow its users to interact with this reconstituted three-dimensional image. For instance, one would want to visualize a video clip from different angles as it is being played, which is what one would expect from a three-dimensional video format. Such control parameters are not offered to users because Littlefield offers only the reconstituted three-dimensional image, which is a finalized product that is not editable. Thus further editing is not possible by all users but only by specific users who would buy this technology. In contrast, our proposed technology offers its users a control over defined audiovisual parameters while the AVMM product is being displayed. This new concept also increases the interaction between users and products.

In U.S. Pat. No. 7,123,696 (2006), Lowe proposes a software program and/or computer hardware configured to enable users to select one or more master clips having predefined gaps, obtain insert data, e.g. an insert clip, seamlessly merge the insert data into the selected master clip to generate a media clip, and distribute the media clip having the insert data to one or more receiving users for playback. Just the fact that the gaps are predefined in the master clips limits the interaction between users and this IAVS. By definition of interaction, the user should be free to interact at any wanted instant and not at predefined instants.

In Greenberg et al. No. 1981/4258385, the producer can change the video characteristics of each video frame during video production; whereas in our proposed IAVES, the users can edit the video of interest while watching. In addition, Greenberg's invention deals with analog tapes while the entire process from production to editing and final recording of IAVES content is done in the digital world for placement on a network.

In Hanna et al. No. 1999/5923791, a user may derive a composite video image by merging foreground and background video image date supplied from a plurality of separate video signal sources employing pattern-key insertion, rather than prior-art color-key insertion. IAVES in the other hand does not use such an advanced degree of image integration but rather a simpler version of mixing two videos by either super-imposing one over the other or adding them next to each other to form a final video.

In Smith et al. No. 2001/6320600 a user may utilize the web to do simple editing tasks without any significant delays using a low-level C code. The delay is never quantitatively mentioned thus this latter cannot be considered valid until a valid search is done on the matter. Also the editing side of this invention is related to copy, cut, and paste frames in a video while IAVES does not allow any of these functions but a simple mixing of pre-existing videos and user videos into a divided screen. Nothing about 3D and Dolby Surround is mentioned either.

In Lowe No. 2006/7123696 users fill in video gaps with their own videos but at prescribed locations and instants. IAVES does not impose any time or location constrain as far as editing is concerned. IAVES′ users can insert their audiovisual content at any instant while the original video is being played. Finally both videos can be played simultaneously and their audio can be mixed at user-defined levels.

In Sideman No. 2002/0116716 users edit videos online. The video streams are either loaded from the user's database or loaded from the server's database. IAVES takes this invention further by showing multiple streams at the same time and not only mix video but also audio contents of any type. Depending on the type of soundcard available on the user's computer, the audio streams can be listened in 3D Surround.

In Greene No. 2003/0218626 the user needs to ask a company to create the personalized DVD or CD of himself/herself singing along with a band in a live concert. In my proposed Interactive AudioVisual Editing System (IAVES), the user can create the content without the need of an external company just by simply using the database of videos available on the server and by using a webcam combined with a microphone connected to a computer. As a reminder, the database contains both videos placed there by other users or by content producers via our company. The other major difference with respect to IAVES is that the content created by Greene is only sent out to the user so it is the user's task to place that content on a server, which may not be possible because the content needs to be ripped, digitized, and uploaded to an appropriate server with the correct format. This process requires special hardware and software which may not be available to the average customer. IAVES bypasses all these steps by allowing its users to save their personalized video onto a server and share it with other users on the same network.

In Kim No. 2004/0150663 the proposed platform is certainly of use for our proposed IAVES since it utilizes video editing online but does not fully cover all the features proposed by IAVES such as 3D sound and video switching between multiple cameras while watching a video and more.

In Belhumeur et al. No. 2005/0034076 the combining of multiple video streams in time and in space simultaneously is disclosed. The user of this system can then locate the different video layers in time as the video is being played. This concept is in line with the general idea of IAVES but our proposed idea does not need so much processing by its users. In fact the user only needs to upload a video stream, an audio stream, some title and graphical data if desired, and a fixed location where the personal video will be displayed along with an original video selected from a server. The user is then allowed to mix audio levels to match the user's data with the original data being shown.

In Sitomer No. 2006/0206526 offers the basic function of our proposed IAVES without describing the existence of multiple camera angles available while watching a video shot in the proposed format as well as the existence of 3D Surround sound while watching a video. On top of these capabilities, IAVES also offers the editing tools proposed by Sitomer with the addition of audio and video mixing.

In Lerman et al. No. 2006/0259588 a website video posting interaction is described in this invention is a consequence of the IAVES application, which might use this concept in order to deploy its information after a video content is being edited. But it is certainly not a component of our invention.

In Hamada et al. No. 2007/0022378 a digital mixer which is a tool that will be used by our proposed IAVES to mix audio and video data over the internet or any other type of web browser. But it is unrelated to what the said invention is.

In Lovejoy et al. No. 2007/0234214 an online capability of an editing system without the 3D Surround and camera switching capabilities of our proposed IAVES. It is certain that IAVES will use the web in order to operate its editing tools but the user's integration and interactivity will be extended to a higher degree of involvement while the audio and video quality will be raised to 3D Surround and HD (High Definition) over the web.

In Shore No. 2007/0274683 users create and compose their own video clip based on camera shots from different angles recorded at a particular event and this over the internet. This concept is only good for live performances as described in the patent application. Also this platform does not allow its users to load any personal audiovisual content, which our proposed IAVES does.

In Thomson Licensing S.A. No. WO 2001/35415 technology related to recordable DVDs only even though it talks about adding user data to an existing stream. Furthermore none of the processed data is used online, i.e. on the internet but rather placed on a DVD.

MySpace.com allows its users to display a webpage that incorporates personalized media in order to interact with other members of the same website. Unfortunately, the level of interactivity is limited because the users are not allowed to edit any of the displayed media besides their own.

YouTube.com allows its users to upload and display any kind of video clip that could be a produced video or self-made video. This website has been one of the biggest hits on the multimedia market in the year 2006. This in fact shows that multimedia users want to interact more with the entertainment industry but once again they are technologically limited because of the low level of customizability offered to them by such websites. In this case, only the following audiovisual parameters are offered: video/display parameters: screen size, stop, play, rewind, and fast forward, audio parameters: volume. No editing is allowed and interactivity is totally absent. A simple improvement could be to insert a self-made video into an original video and save that file as a customized file. This is without mentioning all the other audiovisual control parameters that could be added to online interaction, such as graphics, animations, pictures, text files, audio files, video files, or any user-defined digital content.

### BRIEF SUMMARY OF THE INVENTION

The invention, an interactive audiovisual editing system (IAVES), allows its users to customize and personalize any audiovisual/multimedia (AVMM) product by means of a controller which will allow them to introduce command inputs, personalized data, record, save, and/or store their customized version of the product on a hardware/software equipped system and share that product with other IAVES and non-IAVES users via a distributed network. What is meant by editing is that users can input their own AVMM data into the product to personalize it, such as graphics, animations, pictures, text files, audio files, video files, or any user-defined digital content.

In addition, this IAVES introduces a new AVMM recording/filming format allowing its users to have control over AVMM parameters which will, in turn, alter the AVMM product and allow interaction between users and products. What is meant by control over AVMM parameters is that users can change both audio and video settings thanks to this new AVMM recording/filming format, which will allow user-defined commands to happen. Furthermore, this new AVMM recording/filming format offers multi-dimensional audio (Mono, Stereo, all Dolby Surround formats) and video (2D and 3D formats) options to its users. In case that the AVMM product is recorded/filmed in this new format, while users control the AVMM parameters, the displayed AVMM data will change accordingly to the users' commands. Thus, instead of being exposed to prescribed audiovisual patterns, users can now change these patterns by choosing from a library of commands. The selected online patterns chosen by the users' commands can be saved with the users' personal data to form a final custom-made AVMM product, which can in turn be placed and shared with other users over a distributed network. This last option is offered to users only if they use an AVMM product that was initially recorded/filmed in this new AVMM format introduced here. Some examples of applications for this IAVES are, but not limited to computers including software, hardware and virtual reality applications, the internet including web and multimedia technologies, computer games, cell phones connected via a network, television including analog and digital audiovisual technologies, attending live events, theatres including 2D and 3D technologies, and any combination of the previous that would constitute a new IAVS.

### BRIEF DESCRIPTION OF THE DRAWINGS

Other objects and advantages of the invention will become apparent from a study of the following specification when viewed in the light of the accompanying drawings, in which:

FIG. 1 is a block diagram of the processing steps of the system.

### DETAILED DESCRIPTION OF THE INVENTION

The IAVES users place a command input through an AVMM controller, input which is considered as an order to be processed and executed by the IAVES hardware/software. This latter returns a corrected audiovisual media or data through the AVMM display.

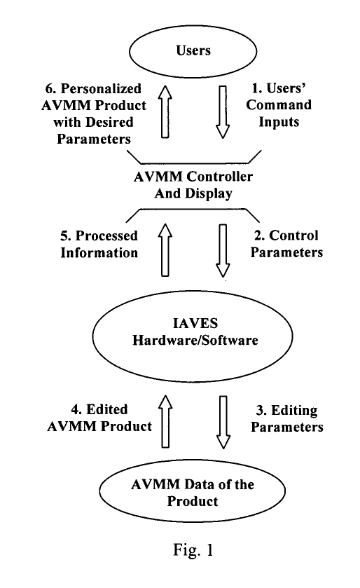

Referring now to FIG. 1, Users place a command input through the AVMM controller 1. This command is changed into control parameters understood by the IAVES hardware/software 2. The IAVES hardware/software applies these commands to the AVMM product data/media 3. The edited AVMM data/media is returned to the IAVES hardware/software for output 4. The processed information is put into an AVMM format that can be displayed to the users 5. Lastly, the personalized AVMM data/media including the desired changes is displayed to the users 6.

In the first mode of operation, IAVES users can interact with any existing AVMM product in the same way that other IAVSs such as audiovisual playback devices do by offering basic functions. But the new IAVES will allow its users to add their personal data/media (e.g. graphics, animations, pictures, text files, audio files, video files, or any user-defined digital content) to the original AVMM data/media, save that personalized AVMM product, and share it with other users of the IAVES over a distributed network.

In the second mode of operation, IAVES users are offered to use the new AVMM recording/filming format. This option allows the IAVES users to change the AVMM parameters via a controller that accepts their command inputs. In this mode of operation, the AVMM settings will not be fixed as presented in all other existing AVMM products, but will be changeable by the users by means of a controller that will enable them to choose from a library of defined commands. Again users will be allowed to save their personalized data/media which now includes their command inputs as well, and as before, save the personalized AVMM product and share it with other IAVES users over a distributed network. Examples of control parameters are the volume of an instrument in a video clip, the camera angle in a specific shot or the insertion of a graphical object to the original video.

The new AVMM recording/filming format available in the second mode of operation comprises the choice between several two-dimensional and three-dimensional audio formats, e.g. Mono, Stereo, Dolby Surround, and two-dimensional and three-dimensional video formats (2D, 3D). IAVES users then have the choice to ask the system to view and listen to the AVMM product in any combination of the mentioned AVMM formats. Also the control parameters will be related to audio, video and any other AVMM parameter that exists in existing AVMM products as well as AVMM products developed under the proposed IAVES.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. An interactive audiovisual editing system (IAVES), comprising:
(a) a hardware/software component that can respond to users' command inputs and process an audiovisual/multimedia (AVMM) data/media accordingly to the users' intention and display the processed data/media back to them via an AVMM display;
(b) an AVMM display that allows users to view and listen to AVMM data/media;
(c) a controller that allows users to enter AVMM command inputs into the system and interact with AVMM data/media via defined AVMM parameters;
(d) a new recording/filming format that gives the IAVES users the option of viewing and listening to their AVMM data/media in different audio and video formats including two-dimensional and three-dimensional formats;
(e) the capability of using any existing AVMM format as well as the new AVMM recording/filming format described above, offering even more interactive capabilities to the IAVES users to control additional AVMM parameters;
(f) a data/media storage device, which could be remote via a network or not, and that can store data/media based on users' actions; and
(g) the capability to connect to the outside world via a distributed network for sharing data/media with other IAVES and non-IAVES users.

2. An interactive audiovisual player/recorder/editor, comprising:
(a) the capability for the user to navigate in the AVMM content selected from the IAVES library via a player/recorder with the following option to play, stop, rewind, fast forward, and record the user-edited AVMM;
(b) the capability to add content to a selected AVMM such as text, image, graphics, animation, audio, video, background, and edit video parameters such as colors, tones, and other video parameters related to image viewing;
(c) the capability for the user to upload text content to the selected AVMM from the IAVES library where the format of the user-produced text content is digital and can be of any common commercially available format;
(d) the capability for the user to upload image/graphical content to the selected AVMM from the IAVES library where the format of the user-produced image/graphical content is digital and can be of any common commercially available formats;
(e) the capability for the user to upload a self-produced image/graphical background to the selected AVMM from the IAVES library;
(f) the capability for the user to select a background from the background library of the IAVES where the format of the user-produced background content must be digital and can be of any common commercially available formats;
(g) the capability for the user to listen to audio streams/files in mono, stereo, Dolby Digital X including Dolby Surround 5.1, Dolby Surround 6.1, Dolby Surround 7.1, and Dolby Surround 8.1, Dolby Digital Live, Dolby Digital Surround EX, Dolby Digital Plus, and Dolby TrueHD as far as the user has the necessary hardware that supports such formats;
(h) the capability for the Dolby Surround sound to change automatically with the camera angles to have the sound move towards the camera target;
(i) the capability for the user to mix user-defined audio data via a mixer that allows the user to mix self-produced audio track to the played AVMM selected from the IAVES library;
(j) said mixer allowing the user to disable existing audio track(s) on the AVMM being played from the IAVES library and replace that/those track(s) with self-produced audio track(s) where the format of the user-produced audio content is digital and can be of any common commercially available formats;
(k) the capability for the user to upload a self-produced video data or video stream into the IAVES and play the uploaded video data or video stream simultaneously with any selected video from the IAVES library where the format of the user-produced video content is digital and can be of any common commercially available formats;
(l) the capability for the user to change audio parameters of the AVMM content selected from the IAVES library where the audio parameters include volume/level, panning, gain, equalizers (graphical or not), and audio effects such as flanger, doppler, chorus, reverb, delay, phaser, compressor, distorsion, gain, vocoder, autotune, amplifier simulation, limiter, noise gate, wah wah, filter, exciter, enhancer, oscillator, modulator, decimator, analog record, vibrato, tremolo, resonator, scratch, auto panning, detune, pitch shifter, rotary speaker, reverse, and any combination of the audio parameters;
(m) the capability for the user to switch between different digital cameras allowing the IAVES user to view a scene from different angles;
(n) the capability for the user to zoom in and out on user-defined digital cameras allowing the IAVES user to view a shot from a closer or farther point;
(o) the capability for the user to define a rectangular frame anywhere into the visual display space and play a user-produced uploaded video data or video stream in that user-defined frame while the AVMM selected from the IAVES library is being played; and
(p) the capability for the user to change the video parameters of the AVMM content selected from the IAVES library.

3. An interactive audiovisual content viewer, comprising the capability for the user to view and interact with multimedia films and movies.

4. A multi-platform interactive audiovisual application, comprising:
(a) the capability to run on a digital cable network;
(b) the capability to run on the national digital television network;
(c) the capability to run on the internet;
(d) the capability to run on Apple's iTV system;
(e) the capability to run on a digital optical network;
(f) the capability to run on a digital audiovisual multimedia (AVMM) player;
(g) the capability to run on Apple's ipod system;
(h) the capability to run on a digital wireless network;
(i) the capability to run on a digital wireless cellular phone network;
(j) the capability to run on Apple's iphone system;
(k) the capability to run on a digital satellite network;
(l) the capability to run on a Personal Computer (PC) or a Mac (Apple) computer;
(m) the capability to run from a DVD;
(n) the capability to run from a program or software that needs to be installed;
(o) the capability to run on a video game console;
(p) the capability to run on a Microsoft's XBOX video game console;
(q) the capability to run on a Nintendo Wii video game console;
(r) the capability to run on Nintendo GameCube video game console;
(s) the capability to run on Sony's Playstation video game console; and
(t) the capability to run on a HD-DVD or BlueRay audiovisual digital formats.
